(19) United States
(12) Patent Application Publication
(10) Pub. No.: US 2011/0107360 A1
(43) Pub. Date: May 5, 2011

(54) Optical disk drive

(76) Inventors: Ming-Hung Chung, Taipei City (TW); Yung-Lung Lee, Taipei City (TW); Chun-Lung Ho, Taipei City (TW)

(21) Appl. No.: 12/657,133

(22) Filed: Jan. 14, 2010

(30) Foreign Application Priority Data
Nov. 4, 2009 (CN) 200910207987.3

(51) Int. Cl. G11B 33/02

(52) U.S. Cl. 720/600; G9B/33.002

(57) ABSTRACT

An optical disk drive for improving the snap fit structure of the bezel is provided. The optical disk drive comprises a main body, a top cover and a bezel. The main body further comprises an optical pickup head and a spindle motor. The top cover comprises an aperture. The bezel comprises a snap fit structure for interlocking the aperture. The snap fit structure comprises a snap fit protrusion and a curved surface of the snap fit protrusion is used to engage with the aperture.

### FIELD OF THE INVENTION

The present invention relates to an optical disk drive and more particularly to improving the snap fit structure of the bezel of the optical disk drive.

### BACKGROUND OF THE INVENTION

With increasing applications of personal computers and multimedia techniques, the data storage media with high data storage density are now rapidly gaining in popularity. Optical disks such as compact disks (CDs), video compact disks (VCDs) and digital versatile disk (DVDs) are widely employed to store considerable digital data due to features of low cost, high capacity and portability. Accordingly, optical disk drives become essential components for reading data from optical disks.

Referring to FIGS. 1 and 2, which shows the conventional optical disk drive and the partially separated view of the optical disk drive, respectively. The optical disk drive 1 has a bezel 11, a top cover 12, a tray panel 13, a main body 14 and a tray 15. The tray 15 is moveable into/out of the optical disk drive 1 and the tray 15 has a recess for placing an optical disk. When the optical disk is placed on the recess, the tray 15 is moved into the optical disk drive 1 for reading or writing data on the optical disk. The bezel 11 has an opening 111. After the tray panel 13 is connected to the tray 15 and the tray 15 is moved into the drive 1, the opening 111 is covered by the tray panel 13. By the tray panel 13, the external substances are blocked outside the drive 1. The main body 14 comprises a pickup head for reading/writing the disk, a spindle motor for rotating the disk. The drive 1 also has other common elements, for example, a stepping motor for moving the pickup head, which are not disclosed herein.

Referring FIG. 3, it shows how the bezel is connected to the top cover. After the top cover 12 is connected to the main body 14, the bezel 11 is connected to the top cover 12. Therefore, the bezel 11, tray panel 13, and top cover 12 prevent the external substances from going into the drive 1 and destroying the elements inside the main body 14. In addition, a broken piece of the rotating disk, which has high impact force, is not flying out of the drive 1 so that a user is protected from the flying broken piece of the rotating disk by the protection of the bezel 11, tray panel 13, and top cover 12. Specifically, the metal top cover 12 and the bezel 11 which has a buffer structure can reduce the impact force of the flying broken piece and the flying broken piece is held inside the drive 1.

As shown in FIGS. 3 and 4, the bezel 11 has a snap fit structure 112 disposed on both sides of the bezel 11. A snap fit protrusion 113 is positioned in accordance with an aperture 121 on the frame of the top cover 12. The bezel 11 is connected to the top cover 12 by the snap fit protrusion 113 interlocking the aperture 121. The top view of the bezel and the sectional view of the bezel being connected to the top cover are shown in FIGS. 4 and 5. The snap fit protrusion 113 has a perpendicular surface 1131. When the snap fit protrusion 113 interlocks the aperture 121, the perpendicular surface 1131 engages with the edge of the aperture 121. Therefore, the bezel 11 is not separated from the drive 1 in the direction of arrow X.

However, the rotating speed of the spindle motor is getting higher so that the drive 1 can access the disk with higher speed and large amounts of data. In the mean while, the broken piece of the optical disk will have higher impact force (momentum). When the flying broken piece hits the bezel 11, the buffer structure of the bezel 11 cannot totally reduce the impact force of the flying broken piece. Also, a torque is generated so that the snap fit protrusion 113 is not totally engaged with the edge of the aperture 121. In other words, the perpendicular surface 1131 is not totally engaged with the edge of the aperture 121 as shown in FIG. 6. Consequently, the bezel 11 is deformed in the direction of arrow X and a gap 114 is formed between the top cover 12 and the bezel 11 as shown in FIG. 7. Because the snap fit protrusion 113 cannot interlock the aperture 121, when the bezel 11 is continuously hit by the flying broken pieces, the bezel 11 has more deformation in the direction of arrow X. Then the gap 114 becomes larger which increases the possibility of letting the flying broken pieces out of the drive 1 via the gap 114. Eventually, the flying broken pieces of the disk may injure the user using the drive 1.

Therefore, the snap fit protrusion of the conventional optical disk drive is not appropriate for higher rotating speed of the spindle motor. And there is a need to improve the problem described above.

### SUMMARY OF THE INVENTION

The present invention provides simple structure of the optical disk drive for preventing the snap fit protrusion from separating an aperture of the top cover.

In accordance with an aspect of the present invention, there is provided an optical disk drive. The optical disk drive comprises a main body, a top cover and a bezel. The main body further comprises an optical pickup head and a spindle motor. The top cover comprises an aperture. The bezel comprises a snap fit structure for interlocking the aperture. The snap fit structure comprises a snap fit protrusion and a curved surface of the snap fit protrusion is used to engage with the aperture.

In accordance with another aspect of the present invention, there is provided an optical disk drive. The optical disk drive comprises a main body, a top cover and a bezel. The main body further comprises an optical pickup head and a spindle motor. The top cover comprises an aperture. The bezel comprises a snap fit structure for interlocking the aperture. The snap fit structure comprises a snap fit protrusion and an inclined surface of the snap fit protrusion is used to engage with the aperture.

According to an embodiment of the present invention, the curved surface is a single continuous surface or the curved surface is composed of several discontinuous surfaces.

According to an embodiment of the present invention, a perpendicular surface of the snap fit protrusion connects the curved surface.

According to an embodiment of the present invention, the snap fit protrusion has a hook shape.

### BRIEF DESCRIPTION OF THE DRAWINGS

The above contents of the present invention will become more readily apparent to those ordinarily skilled in the art after reviewing the following detailed description and accompanying drawings, in which:

FIG. 1 schematically illustrates the conventional optical disk drive;

FIG. 2 shows the partially exploded view of the conventional optical disk drive in FIG. 1;

FIG. 3 schematically illustrates the bezel connecting to the top cover;

FIG. 4 shows the partially view of the bezel in FIG. 3;

FIG. 5 shows the sectional view after the bezel is connected to the top cover;

FIG. 6 shows that the snap fit protrusion does not interlock the top cover;

FIG. 7 shows that the bezel is deformed by the flying broken piece;

FIG. 8 schematically shows the optical disk drive of the present invention;

FIG. 9 shows the bezel of the present invention;

FIG. 10 shows the top view of the bezel in FIG. 9;

FIG. 11 shows an enlarge view of the snap fit protrusion of the bezel;

FIG. 12 shows the sectional view after the bezel is connected to the top cover;

FIG. 13 shows a second embodiment of the snap fit structure; and

FIG. 14 shows a third embodiment of the snap fit structure.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

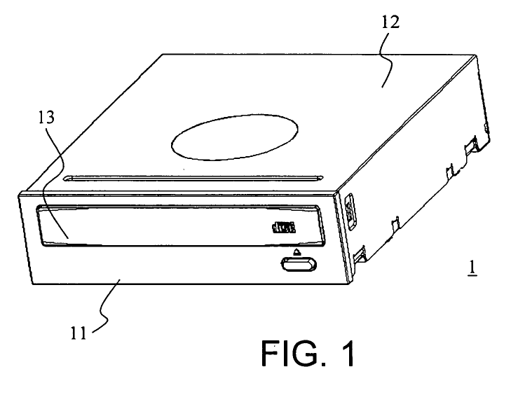

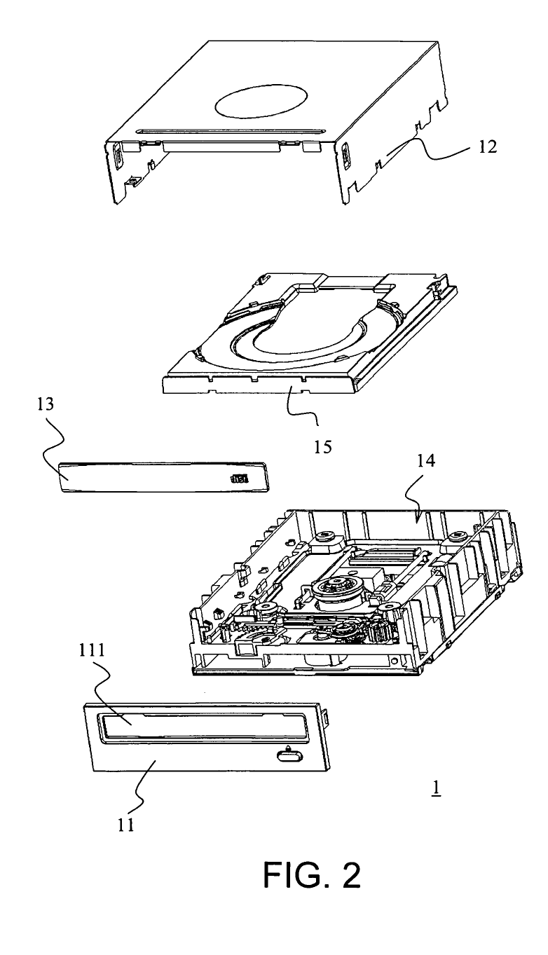

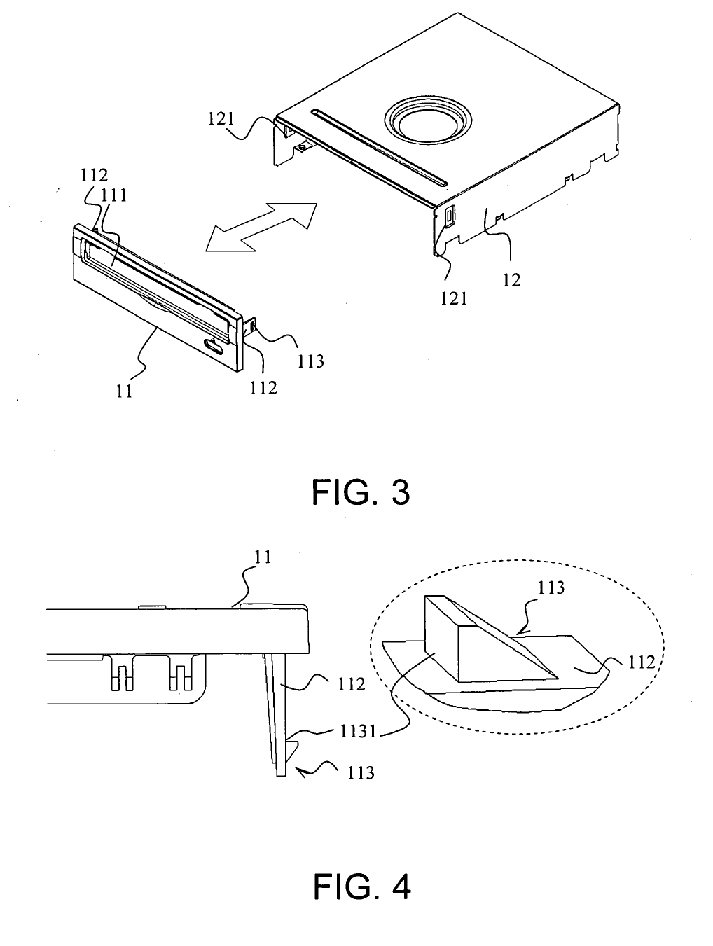

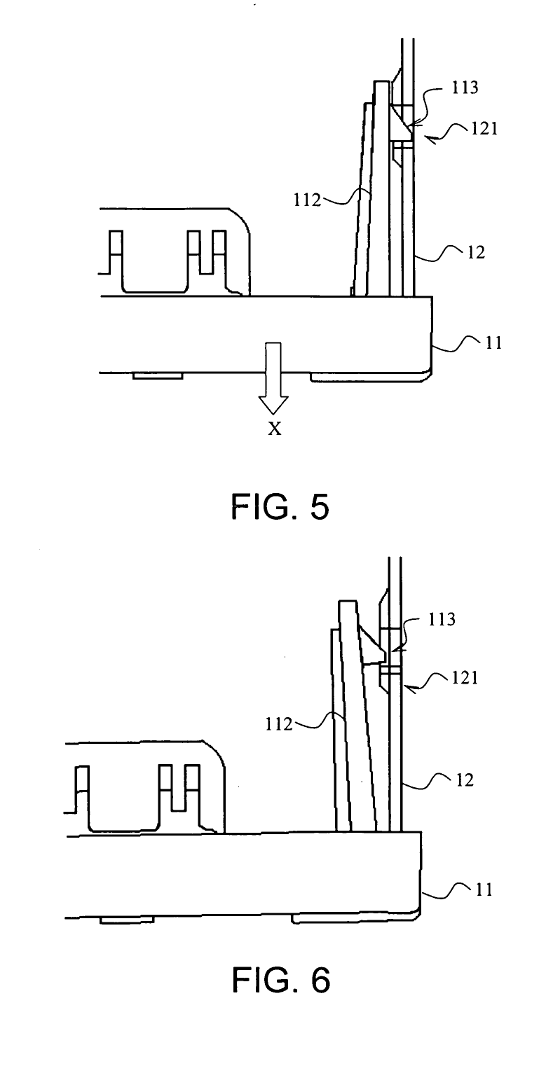

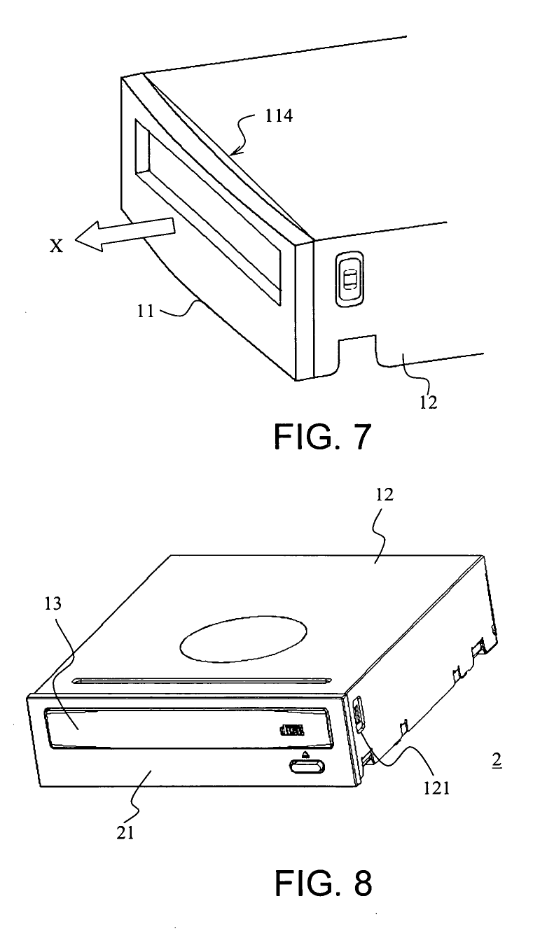

Referring to FIG. 8, it shows the optical disk drive of the present invention. In FIG. 8, the same numeral of the elements represents the same elements shown in FIG. 1 so that the descriptions are omitted herein.

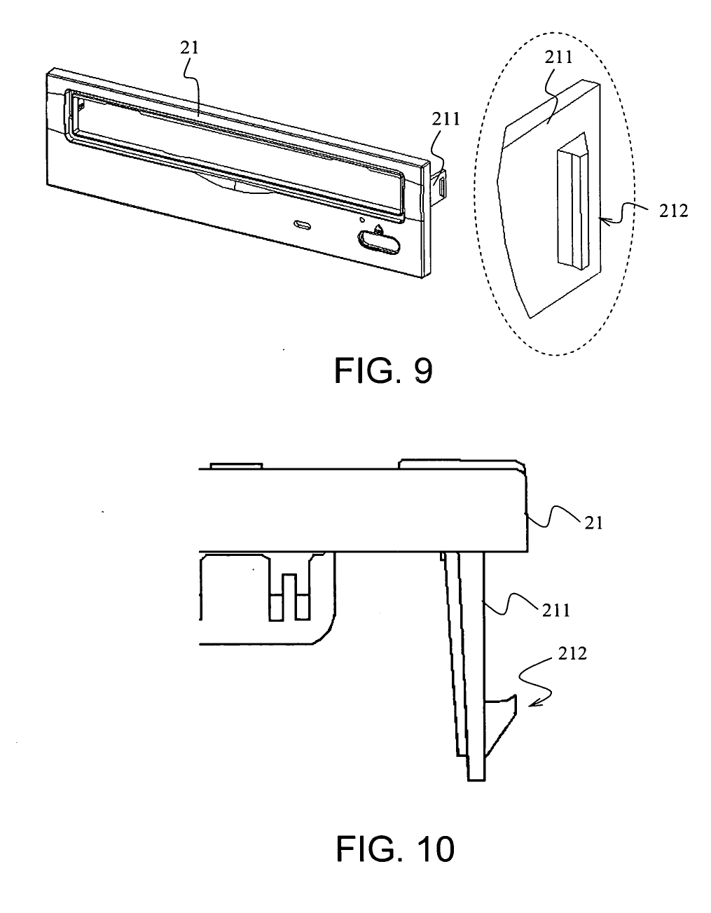

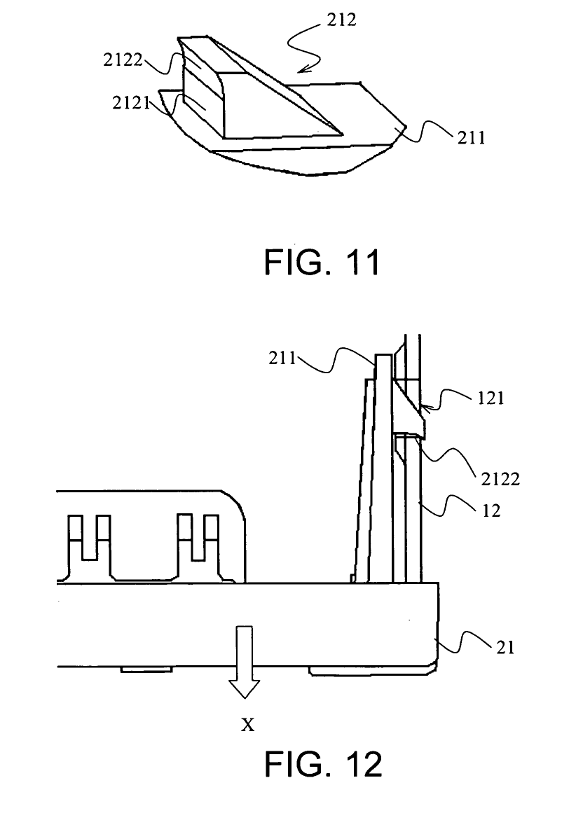

The difference between the conventional drive and the present invention is that there is a curved surface of the snap fit protrusion for engaging with the edge of the aperture of the top cover. The bezel of the present invention is shown in FIG. 9. The bezel 21 comprises at least one snap fit structure 211. The top cover 12 comprises at least one aperture 121 on the frame in accordance with the snap fit structure 211. The bezel 21 is connected to the top cover 12 via the snap fit protrusion 211 interlocking the aperture 121. The bezel, top view of the bezel and the enlarge view of the snap fit protrusion is shown in FIGS. 9, 10 and 11, respectively. The snap fit structure 211 comprises a snap fit protrusion 212. The snap fit protrusion 212 comprises a perpendicular surface 2121 and a curved surface 2111. When the snap fit protrusion 211 interlocks the aperture 121, the curved surface 2122 is engaged with the edge of the aperture 121 so that the bezel 21 is connected to the top cover 12.

Referring to FIG. 12, it shows the sectional view after the bezel is connected to the top cover. As shown in FIG. 12, the curved surface 2122 of the snap fit protrusion 212 is engaged with the edge of the aperture 121 so that the bezel 21 is not separated from the drive 2 in the direction of arrow X. When the flying broken piece of the high rotating speed disk hits the bezel 21, the curved surface 2122 can resist the impact force of the flying broken piece in the direction of arrow X. Therefore, no gap or maybe a small gap is generated between the top cover 12 and the bezel 21. Consequently, no flying broken piece of the optical disk is flying out of the drive 2 and the user is not injured by the flying broken piece.

Although the snap fit protrusion 212 has a perpendicular surface 2121 and a curved surface 2122, people skilled in the art can change the shape of the surfaces to satisfy their needs. For example, the perpendicular surface 2121 can be changed to a curved surface or the curved surface 2122 is changed to be multiple discontinuous surfaces. Therefore, the contacting surface of the snap fit protrusion between the snap fit protrusion and the aperture can be a single curved surface, two or multiple curved surfaces. Moreover, the curved angle is designed that the snap fit protrusion has a hook shape so that the top cover and the bezel is firmly fixed with each other. In addition, the curved surface 2122 can be changed to an inclined surface connecting to the perpendicular surface 2121. The inclined surface is a flat surface and the inclined surface is engaged with the edge of the aperture.

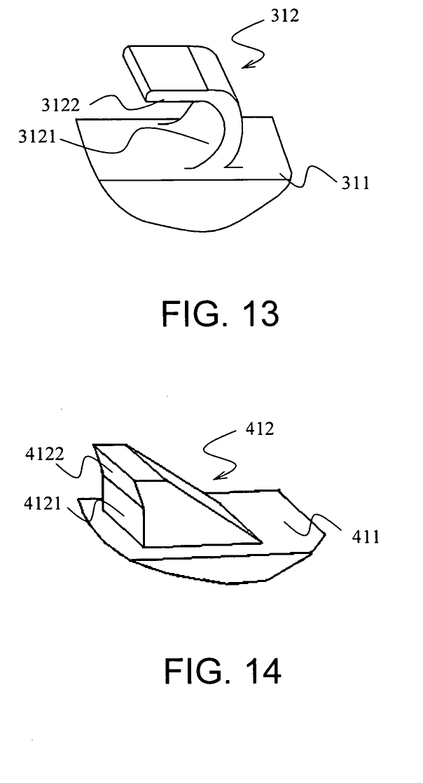

Referring to FIG. 13, it shows a second embodiment of the snap fit structure. The snap fit structure 311 has a snap fit protrusion 312 for interlocking the aperture of the top cover. The snap fit protrusion 312 has a larger curved angle of the curved surface 3121 so that the snap fit protrusion 312 has a hook shape. When the snap fit protrusion 312 interlocks the aperture 121 of the top cover 12, the curved surface 3121 is engaged with the edge of the aperture 121 and a flat surface 3122 is disposed outside the aperture 121. So that the hook-shaped snap fit protrusion 312 firmly interlocks the aperture 121. And no gap is formed between the top cover 12 and the bezel by the impact force of the flying broken piece.

Referring to FIG. 14, it shows a third embodiment of the snap fit structure. The snap fit structure 411 has a snap fit protrusion 412 for interlocking the aperture of the top cover. The snap fit protrusion 412 has an inclined surface 4122 and a perpendicular surface 4121. When the snap fit protrusion 412 interlocks the aperture 121 of the top cover 12, the inclined surface 4122 is engaged with the edge of the aperture 121. The inclined surface 4122 acts similarly as the curved surface 2122 so that the snap fit protrusion 412 firmly interlocks the aperture 121. And no gap is formed between the top cover 12 and the bezel by the impact force of the flying broken piece.

Therefore, according to the above embodiments of the present invention, the snap fit protrusion has a curved surface or an inclined surface for engaging with the edge of the aperture of the top cover. So that the snap fit protrusion is firmly fixed with the aperture and no gap or maybe a small gap is formed between the bezel and the top cover by the impact force of the flying broken piece of the optical disk. No flying broken piece is flying out of the drive and the user is protected from the flying broken piece. Moreover, the present invention only has small modification of the snap fit protrusion of the conventional drive so that the cost is small but the design is effective.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical disk drive comprising:
a main body comprising an optical pickup head and a spindle motor;
a top cover comprising an aperture; and
a bezel comprising a snap fit structure for interlocking the aperture;
wherein the snap fit structure comprises a snap fit protrusion and a curved surface of the snap fit protrusion is used to engage with the aperture.

2. The optical disk drive of claim 1, wherein the curved surface is a single continuous surface.

3. The optical disk drive of claim 1, wherein the curved surface is composed of several discontinuous surfaces.

4. The optical disk drive of claim 1, wherein a perpendicular surface of the snap fit protrusion connects the curved surface.

5. The optical disk drive of claim 1, wherein the snap fit protrusion has a hook shape.

6. An optical disk drive comprising:
a main body comprising an optical pickup head and a spindle motor;
a top cover comprising an aperture; and
a bezel comprising a snap fit structure for interlocking the aperture;
wherein the snap fit structure comprises a snap fit protrusion and an inclined surface of the snap fit protrusion is used to engage with the aperture.

7. The optical disk drive of claim 6, wherein a perpendicular surface of the snap fit protrusion connects the inclined surface.
